(19) United States
(12) Patent Application Publication
(10) Pub. No.: US 2019/0275888 A1
(43) Pub. Date: Sep. 12, 2019

(54) METHODS AND SYSTEMS FOR PROVIDING VISUAL NOTIFICATIONS IN THE PERIPHERAL VISION OF A DRIVER

(71) Applicant: Honda Motor Co., Ltd., Tokyo (JP)

(72) Inventors: David Michael Kirsch, Torrance, CA (US); Evan Thomas Sullivan, Culver City, CA (US); Joseph Anthony Alequin, Los Angeles, CA (US); Stuart Masakazu Yamamoto, La Mirada, CA (US)

(21) Appl. No.: 15/917,181

(22) Filed: Mar. 9, 2018

(51) Int. Cl. B60K 35/00; B60W 50/14; B60Q 9/00

(52) U.S. Cl. CPC B60K 35/00; B60W 50/14; B60K 2350/1096; B60K 2350/965; B60W 2050/146; B60Q 9/008

(57) ABSTRACT

Systems and methods for providing visual notifications in the peripheral vision of a driver. The system includes a memory that stores instructions for executing processes for providing visual notifications in the peripheral vision of a driver. The system also includes a processor configured to execute the instructions. The instructions cause the processor to: generate a notification based on an output of a driver assistance system, with the output being generated based on one or more objects detected by a sensor of a vehicle or based on a navigational database of the vehicle; and illuminate an indicator embedded in a top portion of a dashboard of the vehicle for providing the notification in the peripheral vision of the driver.

### BACKGROUND

Many modern vehicles include systems designed to increase occupant safety and/or convenience, such as vehicle collision warning systems, lane keeping assistance systems, blind spot detection systems, and global positioning systems. These systems, however, require that a driver alter the line of sight from the road ahead to an infotainment system, side mirrors, and/or the instrumental panel in order to perceive the relevant notifications. As a result, these systems may cause an increased risk to the driver and the vehicle due to distracting the driver from maintaining focus on the road ahead.

### SUMMARY

This summary is provided to introduce a selection of concepts in a simplified form that are further described below in the DETAILED DESCRIPTION. This summary is not intended to identify key features of the claimed subject matter, nor is it intended to be used as an aid in determining the scope of the claimed subject matter.

In one aspect, the present disclosure relates to a system that includes a memory that stores instructions for executing processes for providing visual notifications in the peripheral vision of a driver. The system also includes a processor configured to execute the instructions. The instructions cause the processor to: generate a notification based on an output of a driver assistance system, with the output being generated based on one or more objects detected by a sensor of a vehicle or based on a navigational database of the vehicle; and illuminate an indicator embedded in a top portion of a dashboard of the vehicle for providing the notification in the peripheral vision of the driver.

In a further aspect, the present disclosure relates to a system that includes a driver assistance system that generates a notification based on one or more objects detected by a sensor of a vehicle or based on a navigational database of the vehicle. The system also includes an indicator embedded in a top portion of a dashboard of the vehicle for providing the notification in a peripheral vision of a driver of the vehicle.

In a further aspect, the present disclosure relates to a non-transitory computer-readable storage medium containing executable computer program code. The code includes instructions configured to cause a processor to generate a notification based on an output of a driver assistance system, with the output being generated based on one or more objects detected by a sensor of a vehicle or based on a navigational database of the vehicle. The code also causes the processor to illuminate an indicator embedded in a top portion of a dashboard of the vehicle for providing the notification in the peripheral vision of the driver.

### BRIEF DESCRIPTION OF THE DRAWINGS

The novel features believed to be characteristic of aspects of the disclosure are set forth in the appended claims. In the description that follows, like parts are marked throughout the specification and drawings with the same numerals, respectively. The drawing figures are not necessarily drawn to scale and certain figures may be shown in exaggerated or generalized form in the interest of clarity and conciseness. The disclosure itself, however, as well as a preferred mode of use, further objects and advances thereof, will be best understood by reference to the following detailed description of illustrative aspects of the disclosure when read in conjunction with the accompanying drawings, wherein:

FIG. 1 illustrates a schematic view of an example operating environment of a vehicle system in accordance with aspects of the present disclosure;

FIGS. 2A-2F illustrate example indicators for providing notifications in a peripheral vision of a driver;

FIG. 3 illustrates an exemplary network for managing the vehicle system ;

FIG. 4 illustrates various features of an example computer system for use in conjunction with aspects of the present disclosure; and

FIG. 5 illustrates a flowchart method for providing notifications in a peripheral vision of a driver, according to aspects of the present disclosure.

### DETAILED DESCRIPTION

The following includes definitions of selected terms employed herein. The definitions include various examples and/or forms of components that fall within the scope of a term and that may be used for implementation. The examples are not intended to be limiting.

A “processor,” as used herein, processes signals and performs general computing and arithmetic functions. Signals processed by the processor may include digital signals, data signals, computer instructions, processor instructions, messages, a bit, a bit stream, or other computing that may be received, transmitted and/or detected.

A “bus,” as used herein, refers to an interconnected architecture that is operably connected to transfer data between computer components within a singular or multiple systems. The bus may be a memory bus, a memory controller, a peripheral bus, an external bus, a crossbar switch, and/or a local bus, among others. The bus may also be a vehicle bus that interconnects components inside a vehicle using protocols, such as Controller Area network (CAN), Local Interconnect Network (LIN), among others.

A “memory,” as used herein may include volatile memory and/or non-volatile memory. Non-volatile memory may include, for example, ROM (read only memory), PROM (programmable read only memory), EPROM (erasable PROM) and EEPROM (electrically erasable PROM). Volatile memory may include, for example, RAM (random access memory), synchronous RAM (SRAM), dynamic RAM (DRAM), synchronous DRAM (SDRAM), double data rate SDRAM (DDR SDRAM), and/or direct RAM bus RAM (DRRAM).

An “operable connection,” as used herein may include a connection by which entities are “operably connected”, is one in which signals, physical communications, and/or logical communications may be sent and/or received. An operable connection may include a physical interface, a data interface and/or an electrical interface.

A “vehicle,” as used herein, refers to any moving vehicle that is powered by any form of energy. A vehicle may carry human occupants or cargo. The term “vehicle” includes, but is not limited to: cars, trucks, vans, minivans, SUVs, motorcycles, scooters, boats, personal watercraft, and aircraft. In some cases, a motor vehicle includes one or more engines.

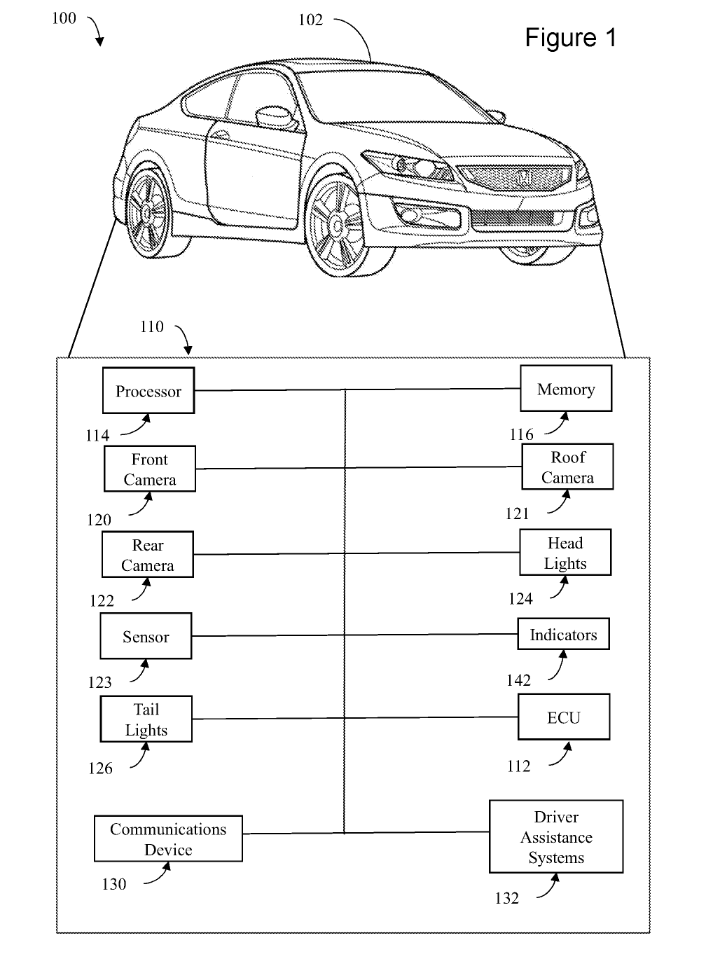

Generally described, the present disclosure provides systems and methods for providing visual notifications in the peripheral vision of a driver. Turning to FIG. 1, a schematic view of an example operating environment 100 of a vehicle system 110 according to an aspect of the disclosure is provided. The vehicle system 110 may reside within a vehicle 102. The components of the vehicle system 110, as well as the components of other systems, hardware architectures, and software architectures discussed herein, may be combined, omitted or organized into various implementations.

The vehicle 102 may generally include an electronic control unit (ECU) 112 that operably controls a plurality of vehicle systems. The vehicle systems may include, but are not limited to, one or more driver assistance systems 132, among others, including vehicle HVAC systems, vehicle audio systems, vehicle video systems, vehicle infotainment systems, vehicle telephone systems, and the like. The vehicle 102 may include a front camera 120, a roof camera 121, a rear camera 122, and/or a sensor 123, such as a LIDAR. In some aspects, each of the front camera 120, roof camera 121, the rear camera 122, and the sensor 123 may be used for monitoring an environment surrounding the vehicle 102, e.g., detecting lanes, vehicles, pedestrians, etc. The front camera 120, the roof camera 121, the rear camera 122, and/or the sensor 123 may provide the detected objects to the one or more driver assistance systems 132, which may include a lane keeping assistance system, a collision warning system, adaptive cruise control, a global position system (GPS), etc.

The vehicle 102 may include head lights 124 and tail lights 126, which may include any conventional lights used on vehicles. In some aspects, the head lights 124 and/or tail lights 126 may be activated or controlled to provide desirable lighting when scanning the environment of the vehicle 102.

The ECU 112 may include internal processing memory, an interface circuit, and bus lines for transferring data, sending commands, and communicating with the vehicle systems. The ECU 112 may include an internal processor and memory, not shown. The vehicle 102 may also include a bus for sending data internally among the various components of the vehicle system 110.

The vehicle 102 may further include a communications device 130 (e.g., wireless modem) for providing wired or wireless computer communications utilizing various protocols to send/receive electronic signals internally with respect to features and systems within the vehicle 102 and with respect to external devices. These protocols may include a wireless system utilizing radio-frequency (RF) communications (e.g., IEEE 802.11 (Wi-Fi), IEEE 802.15.1 (Bluetooth®)), a near field communication system (NFC) (e.g., ISO 13157), a local area network (LAN), a wireless wide area network (WWAN) (e.g., cellular) and/or a point-to-point system. Additionally, the communications device 130 of the vehicle 102 may be operably connected for internal computer communication via a bus (e.g., a CAN or a LIN protocol bus) to facilitate data input and output between the electronic control unit 112 and vehicle features and systems. In an aspect, the communications device 130 may be configured for vehicle-to-vehicle (V2V) communications. For example, V2V communications may include wireless communications over a reserved frequency spectrum. As another example, V2V communications may include an ad hoc network between vehicles set up using Wi-Fi or Bluetooth®.

The vehicle system 110 may also include a processor 114 and a memory 116 that communicate with the front camera 120, the roof camera 121, the rear camera 122, the one or more sensors 123, head lights 124, tail lights 126, communications device 130, one or more driver assistance systems 132, and one or more indicators 142. In some aspects, the one or more indicators may be in communication with the various components of the vehicle system 110 via the communications device 130 and/or the bus of the vehicle 102.

In some aspects, the one or more indicators 142 may be used to display notifications to the driver of the vehicle 102. For example, the one or more indicators 142 may be used to provide notifications related to objects detected by the front camera 120, the roof camera 121, the rear camera 122, and the one or more sensors 123. In further aspects, the one or more indicators 142 may be used to provide notifications related to navigational directions from, for example, the GPS. In further aspects, the one or more indicators 142 may be used to provide notifications related to one or more measurements of the vehicle 102, such as a speed of the vehicle 102, a fuel level or battery charge level of the vehicle 102, revolutions per minute of the vehicle 102, tire pressure, etc.

In some aspects, the one or more indicators 142 may be embedded in a dashboard of an interior cabin of the vehicle. For example, in some aspects, the one or more indicators 142 may be light emitting diodes (LEDs) formed as a circuit having preprogrammed configurations used to provide respective notifications received from the one or more driver assistance systems 132. In further aspects, the one or more indicators 142 may be organic light emitting diodes (OLEDs) that may be printed using smart materials and conform to the shape of the dashboard. Using the OLEDs, the one or more indicators 142 may dynamically generate the notifications, e.g., the one or more indicators 142 may be used to dynamically display a street name based on the navigational directions. In still further aspects, the one or more indicators 142 may be provided beneath perforations formed in the dashboard, such that the one or more indicators 142 illuminate the perforations in dashboard when triggered. In this way, the one or more indicators 142 may be used to provide notifications in the peripheral vision of the driver, as well as in the infotainment system, the side mirrors, or the instrumental panel.

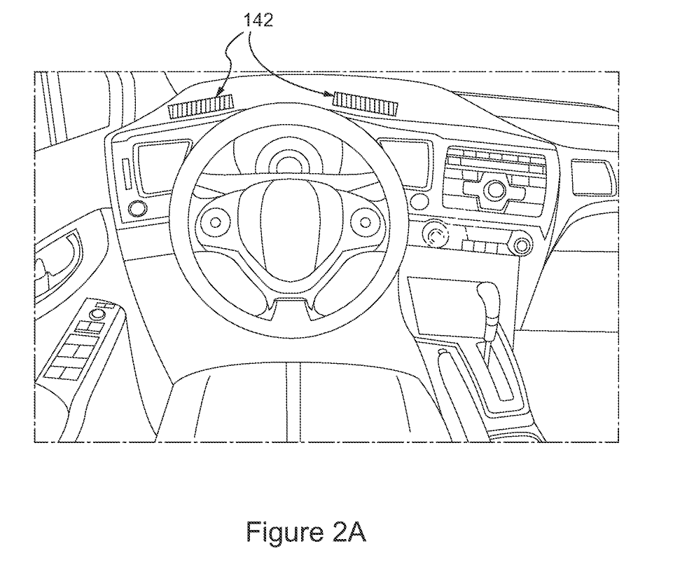

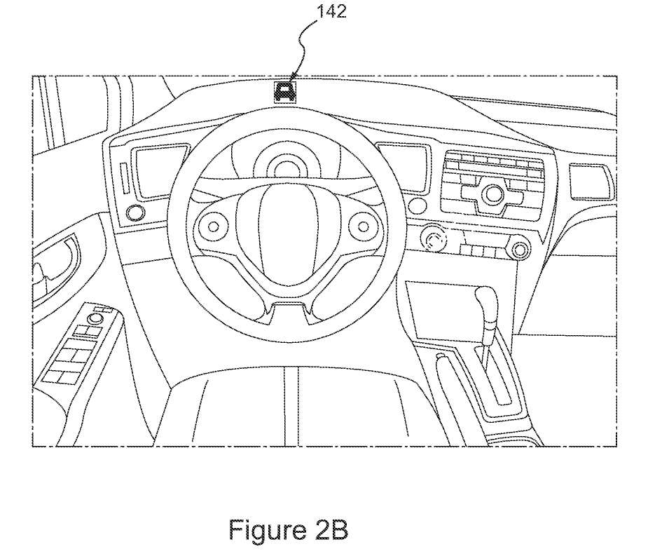

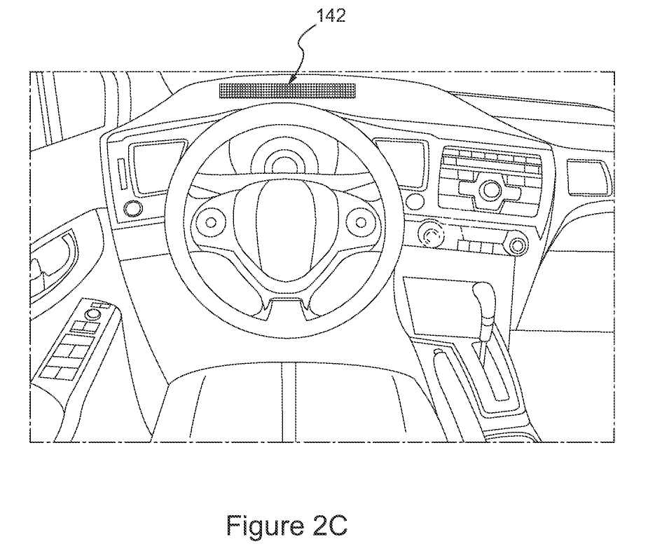

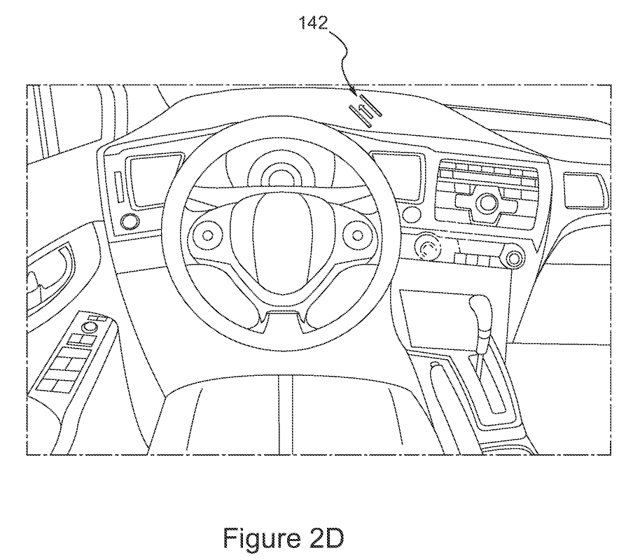

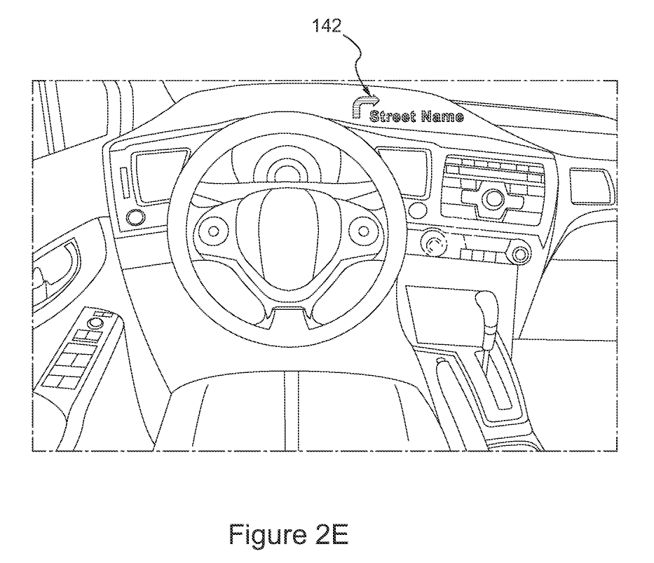

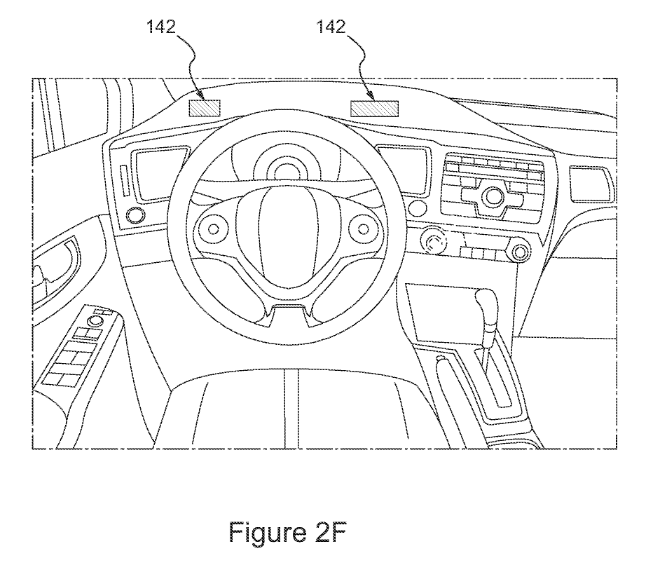

As illustrated in FIGS. 2A-2F, in some aspects, the one or more indicators 142 may include various status lights. FIG. 2A illustrates lane keeping assist status lights 142 that illuminate when the one or more driver assistance systems 132 detect lanes on the road and are turned off when the one or more driver assistance system 132 do not detect the lanes. FIG. 2B illustrates a car ahead status light 142 that illuminates when the one or more driver assistance systems 132 detect a car ahead and turns off when the one or more driver assistance systems 132 do not detect a car ahead. FIG. 2C illustrates an emergency brake alert status light 142 that flashes when the one or more driver assistance systems 132 determine that emergency braking is needed. FIG. 2D illustrates a navigation lane status light 142 that illustrates which lane to follow for navigation directions based on information from the one or more driver assistance systems 132. FIG. 2E illustrates a navigation direction status light 142 that illustrates a turn arrow and street name for a next navigation step based on information from the one or more driver assistance systems 132. FIG. 2F illustrates a blind spot/turn hazard status light 142 that illuminates when the one or more driver assistance systems 132 detect a car in a blind spot of the vehicle 102, pedestrians/cyclists entering the crosswalk, or another turning vehicle. In some aspects, the one or more indicators 142 may use different colors for each of the various notifications being provided, such that the driver may recognize which type of notification is being provided based on the indicator color.

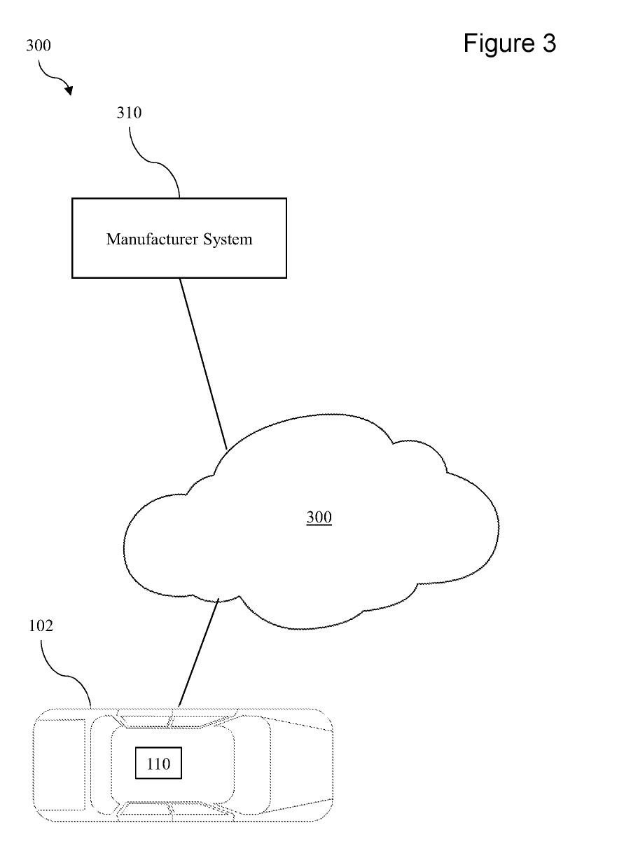

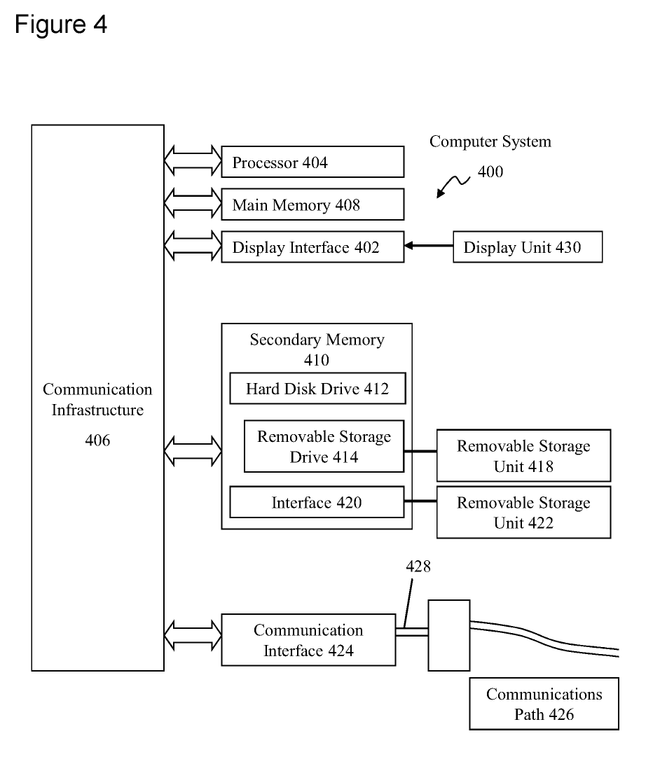

FIG. 3 illustrates an exemplary network 300 for managing the vehicle system 110. The network 300 may be a communications network that facilitates communications between multiple systems. For example, the network 300 may include the Internet or another Internet Protocol (IP) based network. The network 300 may enable the vehicle system 110 to communicate with a manufacturer system 310 to receive, for example, updated navigational data. The manufacturer system 310 may include a computer system, as shown with respect to FIG. 4 described below, associated with one or more vehicle manufacturers or dealers.

Aspects of the present disclosure may be implemented using hardware, software, or a combination thereof and may be implemented in one or more computer systems or other processing systems. In an aspect of the present disclosure, features are directed toward one or more computer systems capable of carrying out the functionality described herein. An example of such a computer system 400 is shown in FIG. 4.

Computer system 400 includes one or more processors, such as processor 404. The processor 404 is connected to a communication infrastructure 406 (e.g., a communications bus, cross-over bar, or network). In one example, processor 114 can include processor 406. Various software aspects are described in terms of this example computer system. After reading this description, it will become apparent to a person skilled in the relevant art(s) how to implement aspects of the disclosure using other computer systems and/or architectures.

Computer system 400 may include a display interface 402 that forwards graphics, text, and other data from the communication infrastructure 406 (or from a frame buffer not shown) for display on a display unit 430. Computer system 400 also includes a main memory 408, preferably random access memory (RAM), and may also include a secondary memory 410. The secondary memory 410 may include, for example, a hard disk drive 412, and/or a removable storage drive 414, representing a floppy disk drive, a magnetic tape drive, an optical disk drive, a universal serial bus (USB) flash drive, etc. The removable storage drive 414 reads from and/or writes to a removable storage unit 418 in a well-known manner. Removable storage unit 418 represents a floppy disk, magnetic tape, optical disk, USB flash drive etc., which is read by and written to removable storage drive 414. As will be appreciated, the removable storage unit 418 includes a computer usable storage medium having stored therein computer software and/or data.

Alternative aspects of the present disclosure may include secondary memory 410 and may include other similar devices for allowing computer programs or other instructions to be loaded into computer system 400. Such devices may include, for example, a removable storage unit 422 and an interface 420. Examples of such may include a program cartridge and cartridge interface (such as that found in video game devices), a removable memory chip (such as an erasable programmable read only memory (EPROM), or programmable read only memory (PROM)) and associated socket, and other removable storage units 422 and interfaces 420, which allow software and data to be transferred from the removable storage unit 422 to computer system 400. In an example, memory 116 can include one or more of main memory 408, secondary memory 410, removable storage drive 414, removable storage unit 418, removable storage unit 422, etc.

Computer system 400 may also include a communications interface 424. Communications interface 424 allows software and data to be transferred between computer system 400 and external devices. Examples of communications interface 424 may include a modem, a network interface (such as an Ethernet card), a communications port, a Personal Computer Memory Card International Association (PCMCIA) slot and card, etc. Software and data transferred via communications interface 424 are in the form of signals 428, which may be electronic, electromagnetic, optical or other signals capable of being received by communications interface 424. These signals 428 are provided to communications interface 424 via a communications path (e.g., channel) 426. This path 426 carries signals 428 and may be implemented using wire or cable, fiber optics, a telephone line, a cellular link, a radio frequency (RF) link and/or other communications channels. The terms “computer program medium” and “computer usable medium” are used to refer generally to media such as a removable storage drive 418, a hard disk installed in hard disk drive 412, and signals 428. These computer program products provide software to the computer system 400. Aspects of the present disclosure are directed to such computer program products. Communications device 130 can include communication interface 424.

Computer programs (also referred to as computer control logic) are stored in main memory 408 and/or secondary memory 410. Computer programs may also be received via communications interface 424. Such computer programs, when executed, enable the computer system 400 to perform the features in accordance with aspects of the present disclosure, as discussed herein. In particular, the computer programs, when executed, enable the processor 404 to perform the features in accordance with aspects of the present disclosure. Accordingly, such computer programs represent controllers of the computer system 400.

In an aspect of the present disclosure where the disclosure is implemented using software, the software may be stored in a computer program product and loaded into computer system 400 using removable storage drive 414, hard drive 412, or communications interface 420. The control logic (software), when executed by the processor 404, causes the processor 404 to perform the functions described herein. In another aspect of the present disclosure, the system is implemented primarily in hardware using, for example, hardware components, such as application specific integrated circuits (ASICs). Implementation of the hardware state machine so as to perform the functions described herein will be apparent to persons skilled in the relevant art(s).

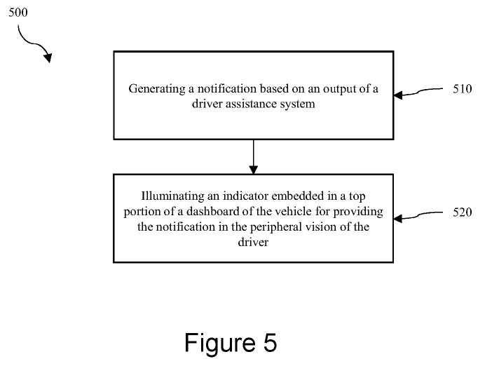

FIG. 5 illustrates a flowchart for providing notifications in a peripheral vision of a driver. The method includes generating a notification based on an output of a driver assistance system 510. In some aspects, the output is generated based on one or more objects detected by a sensor of a vehicle or based on a navigational database of the vehicle. The method also includes illuminating an indicator embedded in a top portion of a dashboard of the vehicle for providing the notification in the peripheral vision of the driver 520.

It will be appreciated that various implementations of the above-disclosed and other features and functions, or alternatives or varieties thereof, may be desirably combined into many other different systems or applications. Also that various presently unforeseen or unanticipated alternatives, modifications, variations, or improvements therein may be subsequently made by those skilled in the art which are also intended to be encompassed by the following claims.

1. A system comprising:
a memory that stores instructions for executing processes for providing respective notifications in a peripheral vision of a driver; and
a processor configured to execute the instructions, wherein the instructions cause the processor to:
generate the respective notifications based on respective outputs of a plurality of driver assistance systems, wherein the respective outputs are generated based on one or more objects detected by a sensor of a vehicle or based on a navigational database of the vehicle;
illuminate a first indicator embedded in a top portion of a dashboard of the vehicle for providing the respective notifications from the plurality of driver assistance systems in the peripheral vision of the driver, wherein the first indicator comprises a plurality of organic light emitting, diodes (OLEDs) beneath perforations formed in the top portion of the dashboard, and wherein the plurality of OLEDs are configured to dynamically illuminate in a shape of a respective image to provide each of the respective notifications in response to receiving the respective outputs of the plurality of driver assistance systems, and wherein the plurality of illuminated OLEDs are directly visible to the driver; and
illuminate a second indictor including at least one of:
an emergency brake alert status light that flashes when a third driver assistance system of the plurality of driver assistance systems determines that emergency braking is needed;
a navigation lane status light that illustrates which lane to follow for navigation directions based on information from a fourth driver assistance system of the plurality of driver assistance systems; and
a navigation direction status light that illustrates a turn arrow and street name for a next navigation step based on information from a fifth driver assistance system of the plurality of driver assistance systems.

2.4. (canceled)

5. The system of claim 1, wherein:
the plurality of OLEDs conform to a shape of the dashboard.

6. The system of claim 1, wherein the first indicator comprises one or more of the following:
a lane keeping assist status light that illuminates when a first driver assistance system of the plurality of driver assistance systems detects lanes on the road;
a vehicle warning light that illuminates when a second driver assistance system of the plurality of driver assistance systems detects another vehicle ahead of the vehicle;
a blind spot/turn hazard status light that illuminates when a sixth driver assistance system of the plurality of driver assistance systems detects another vehicle in, a blind spot of the vehicle, pedestrians or cyclists entering a crosswalk, or another vehicle that is turning.

7. The system of claim 6, wherein the first indicator comprises a plurality of indicators each configured to illuminate a different color.

8. A system comprising:
a plurality of driver assistance systems generating respective notifications based on one or more objects detected by a sensor of a vehicle or based on a navigational database of the vehicle;
a first indicator embedded in a top portion of a dashboard of the vehicle for providing the respective notifications in a peripheral vision of a driver of the vehicle, wherein the first indicator comprises a plurality of organic light emitting diodes (OLEDs) beneath perforations formed in the top portion of the dashboard, and wherein the plurality of OLEDs are configured to dynamically illuminate in a shape of a respective image to provide each of the respective notifications in response to receiving respective outputs of the plurality of driver assistance systems, and wherein the plurality of illuminated OLEDs are directly visible to the driver; and
a second indicator including at least one of:
an emergency brake alert status light that flashes when a third driver assistance system of the plurality of driver assistance systems determines that emergency braking is needed;
a navigation lane status light that illustrates which lane to follow for navigation directions based on information from a fourth driver assistance system of the plurality of driver assistance systems; and
a navigation direction status light that illustrates a turn arrow and street name for a next navigation step based on information from a fifth driver assistance system of the plurality of driver assistance systems.

9.-11. (canceled)

12. The system of claim 8, wherein:
the plurality of OLEDs conform to a shape of the dashboard.

13. The system of claim 8, wherein the first indicator comprises one or more of the following:
a lane keeping assist status light that illuminates when a first driver assistance system of the plurality of driver assistance systems detects lanes on the road;
a vehicle warning light that illuminates when a second driver assistance system of the plurality of driver assistance systems detects another vehicle ahead of the, vehicle;
a blind spot/turn hazard status light that illuminates when a sixth driver assistance system of the plurality of driver assistance systems detects another vehicle in a blind spot of the vehicle, pedestrians or cyclists entering a crosswalk, or another vehicle that is turning.

14. The system of claim 13, wherein the first indicator comprises a plurality of indicators each configured to illuminate a different color.

15. A non-transitory computer-readable storage medium containing executable computer program code, the code comprising instructions configured to cause a processor to:
generate respective notifications based on respective outputs of a plurality of driver assistance systems, wherein the respective outputs are generated based on one or more objects detected by a sensor of a vehicle or based on a navigational database of the vehicle;
illuminate first indicator embedded in a top portion of a dashboard of the vehicle for providing the respective notifications in a peripheral vision of the driver, wherein the first indicator comprises a plurality of organic light emitting diodes (OLEDs) beneath perforations formed in the top portion of the dashboard, and wherein the plurality of OLEDs are configured to dynamically illuminate in a shape of a respective image to provide each of the respective notifications in response to receiving respective outputs of the plurality of driver assistance systems, and wherein the plurality of illuminated OLEDs are directly visible to the driver; and
illuminate a second indicator including at least one of:
an emergency brake alert status light that flashes when a third driver assistance system of the plurality of driver assistance systems determines that emergency braking is needed,
a navigation lane status light that illustrates which lane to follow for navigation directions based on information from a fourth driver assistance system of the plurality of driver assistance systems; and
a navigation direction status light that illustrates a turn arrow and street name for a next navigation step based on information from a fifth driver assistance system of the plurality of driver assistance systems.

16.-18. (canceled)

19. The non-transitory computer-readable storage medium of claim 15, wherein:
the plurality of OLEDs conform to a shape of the dashboard.

20. The non-transitory computer-readable storage medium of claim 15, wherein the first indicator comprises one or more of the following:
a lane keeping assist status light that illuminates when a first driver assistance system of the plurality of driver assistance systems detects lanes on the road;
a vehicle warning light that illuminates when a second driver assistance system of the plurality of driver assistance systems detects another vehicle ahead of the vehicle;
a blind spot/turn hazard status light that illuminates when a sixth driver assistance system of the plurality of driver assistance systems detects another vehicle in a blind spot of the vehicle, pedestrians or cyclists entering a crosswalk, or another vehicle that is turning, wherein when the first indicator comprises a plurality of indicators, each of the plurality of indicators is configured to illuminate a different color.

21. The system of claim 1, wherein two or more notifications of the respective notifications comprise different images at a same location on the dashboard.
